(19) United States
(12) Patent Application Publication
(10) Pub. No.: US 2015/0134158 A1
(43) Pub. Date: May 14, 2015

(54) ICE ALERT SYSTEM AND METHOD OF EVACUATING AN ARCTIC FLOATING PLATFORM FROM A HAZARDOUS ICE CONDITION

(71) Applicant: CONOCOPHILLIPS COMPANY, Houston, TX (US)

(72) Inventors: Dom BERTA, Flower Mound, TX (US); Alex IYERUSALIMSKIY, Houston, TX (US); Brenda K. MASKOS, Houston, TX (US); Chris YETSKO, Richmond, TX (US); George GU, Katy, TX (US); Khalid SOOFI, Katy, TX (US)

(21) Appl. No.: 14/538,176

(22) Filed: Nov. 11, 2014

Related U.S. Application Data
(60) Provisional application No. 61/902,846, filed on Nov. 12, 2013.

(51) Int. Cl. B63B 35/08; G01C 21/20; B63B 35/44

(52) U.S. Cl. CPC B63B 35/08; B63B 35/44; G01C 21/203; B63B 2211/06
USPC 701/21; 114/264; 701/533

(57) ABSTRACT

An ice alert system includes an ice floe monitoring system, and an ice floe forecast system operatively connected to the ice floe monitoring system. The ice floe forecast system is configured to determine a hazardous ice condition. An evacuation system is operatively connected to the ice floe forecast system. The evacuation system is configured and disposed to determine, in response to the hazardous ice condition, a safe harbor location, and a navigational course from an original anchor point to the safe harbor location.

### CROSS-REFERENCE TO RELATED APPLICATIONS

This application is a non-provisional application which claims benefit under 35 USC §119(e) of and priority to U.S. Provisional Application Ser. No. 61/902,846 filed 12 November, 2013, entitled “ICE ALERT SYSTEM AND METHOD OF EVACUATING AN ARCTIC FLOATING PLATFORM FROM A HAZARDOUS ICE CONDITION,” which is incorporated by reference herein in its entirety.

### FIELD OF THE INVENTION

This invention relates to systems and processes for arctic floating platform systems. In another aspect, the invention concerns a system to monitor ice floes, detect hazardous ice conditions, disconnect, re-position, and reconnect an upper hull of an arctic deep water floating platform to a lower hull of the floating platform system.

### BACKGROUND OF THE INVENTION

Offshore oil and natural gas platform systems rely upon above-sea platforms that support drilling and/or processing equipment to extract resources from subsea wells. The above-sea platforms are mounted through a system of supports that extend from the offshore platform to the sea floor. Oftentimes the supports are adjustable to account for changing sea and/or weather conditions. In other cases, the above-sea platform takes the form of a floating platform or upper hull that floats on the sea surface. The above-sea platform is connected to a subsea platform that often times rests on, or just above, the sea floor. The above-sea platform often includes drilling systems, transport systems, support systems, such as electrical power generation, and crew accommodation systems. In addition to above-sea platforms, many offshore platform systems include subsea platforms that support various systems at or near the sea floor.

Subsea platforms include subsea systems that support the above-sea platforms with extraction, storage, and transport of resources such as oil and natural gas. In arctic regions, the floating platform portions are designed to withstand floes of ice traveling across the ocean. However, in some cases, the floes of ice are such that the floating platform portion must be moved or risk damage. Currently, the floes of ice are visually monitored for age and type. If the floe of ice is too thick or moving too fast, it may be desirable to disconnect and move the floating platform portion for a period of time. Determining a good staging position for the floating platform portion is currently based on experience and visual observation of the floes of ice. Once the floes of ice have returned to acceptable levels, the floating platform may be retuned and reconnected to the subsea portion.

### SUMMARY OF THE INVENTION

In accordance with one embodiment, an ice alert system includes an ice floe monitoring system, and an ice floe forecast system operatively connected to the ice floe monitoring system. The ice floe forecast system is configured to determine a hazardous ice condition. An evacuation system is operatively connected to the ice floe forecast system. The evacuation system is configured and disposed to determine, in response to the hazardous ice condition, a safe harbor location, and a navigational course from an original anchor point to the safe harbor location.

In accordance with another exemplary embodiment, an artic floating platform system includes a lower hull portion, an upper hull portion detachably coupled to the subsea platform portion, and an ice alert system coupled to the upper hull portion. The ice alert system includes an ice floe monitoring system, and an ice floe forecast system operatively connected to the ice floe monitoring system. The ice floe forecast system is configured to determine a hazardous ice condition. An evacuation system is operatively connected to the ice floe forecast system. The evacuation system is configured and disposed to determine, in response to the hazardous ice condition, a safe harbor location, and a navigational course to the safe harbor location.

In accordance with still another exemplary embodiment, a method of evacuating an arctic floating platform system includes sensing through at least one of an unmanned aerial vehicle (UAV), and autonomous underwater vehicle (AUV), and a satellite ice floe data of an ice floe at the arctic floating platform system, detecting a hazardous ice condition in the ice floe moving toward the arctic floating platform system, determining a safe harbor location, calculating a navigational course from an original anchor point to the safe harbor location, disconnecting an upper hull portion of the arctic floating platform system from a lower hull, and transporting the upper hull portion to the safe harbor location.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 is a partial perspective view of an arctic floating platform system at an original anchor point including an ice alert system, in accordance with an exemplary embodiment;

FIG. 2 is a block diagram illustrating the ice alert system of FIG. 1;

FIG. 3 is a screen snap-shot of a graphical representation of an ice floe including a hazardous ice condition;

FIG. 4 is a partial perspective view of support vessels moving toward the arctic floating platform system of FIG. 1 in response to a hazardous ice condition;

FIG. 5 is a partial perspective view of support vessels transporting an upper hull portion of the arctic floating platform system from the original anchor point toward a safe harbor location;

FIG. 6 is a partial perspective view of the upper hull portion of the arctic platform system at the safe harbor location as the hazardous ice condition passes; and

FIG. 7 is a partial perspective view of the upper hull portion being transported back to the original anchor point.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

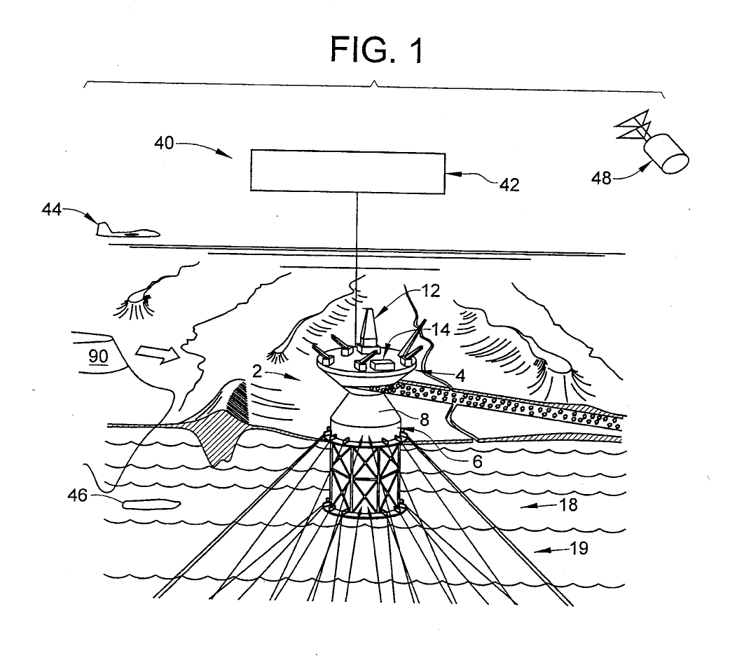

An arctic floating platform system, in accordance with an exemplary embodiment, is illustrated generally at 2, in FIG. 1. Arctic floating platform system 2 includes an upper or floating hull portion 4 that is detachably mounted to a lower or subsea hull portion 6 through a cone portion 8. Cone portion 8 enables arctic floating platform system 2 to withstand ice loads applied by floating ice floes. Upper hull portion 4 supports resource exploration and/or extraction systems, indicated generally at 12, as well as crew accommodation/support systems, indicated generally at 14. Lower hull portion 6 is secured to the sea floor at an original anchor point 18 through a plurality of anchor lines 19.

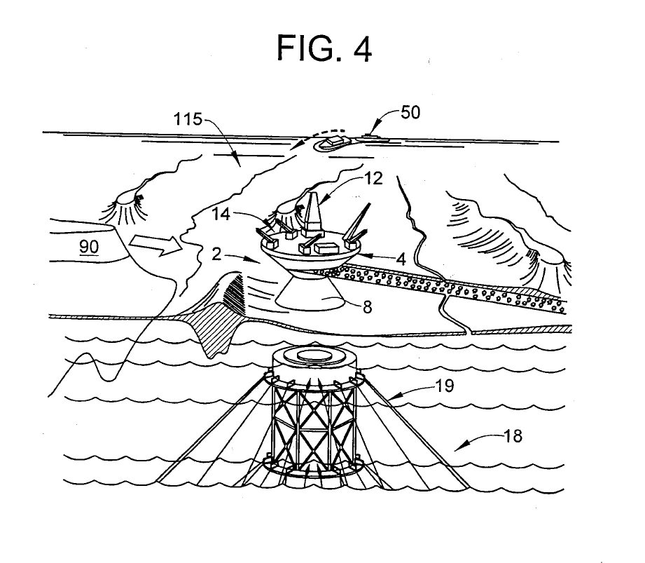

In accordance with an exemplary embodiment, arctic floating platform system 2 includes an ice alert system 40 which, as will be detailed more fully below, identifies hazardous ice conditions and provides support for evacuating/temporarily relocating upper hull portion 4. Ice alert system 40 includes an ice floe monitoring system 42 that receives data from unmanned aerial vehicles (UAV) 44, autonomous undersea vehicles (AUV) 46, satellites 48 as well as various support vessels 50 (see, FIG. 4) that generally take the form of ice breakers. At this point it should be understood that the term “hazardous ice condition” should be understood to include an ice feature that is predicted to exceed ice loading parameters of the arctic floating platform system 2 if upper hull portion 4 is left attached to lower hull portion 6.

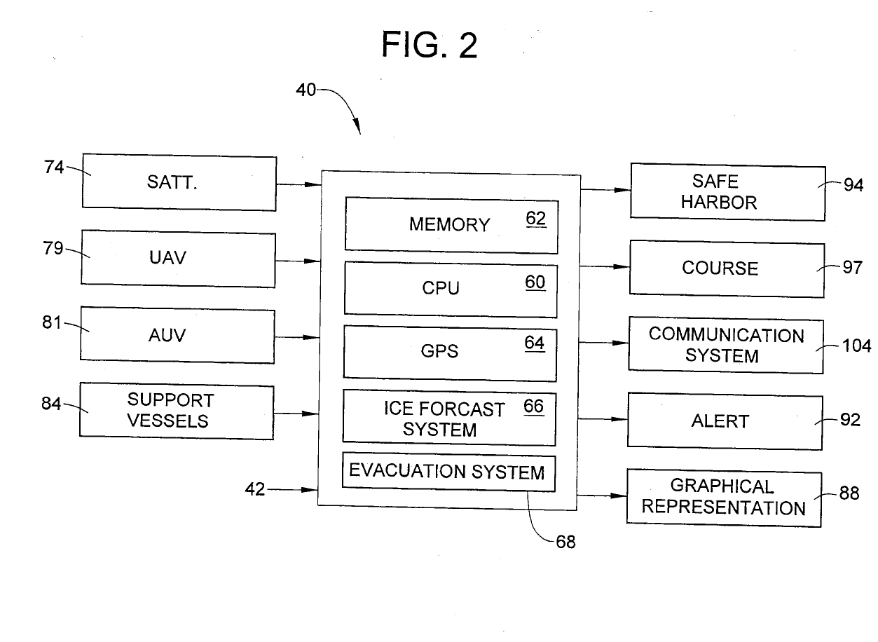

In accordance with an exemplary embodiment illustrated in FIG. 2, ice alert system 40 includes an ice floe monitoring system 42 having a central processor (CPU) 60, a memory 62, a global positioning satellite system (GPS) 64, an ice floe forecast system 66, and an evacuation system 68. In addition, ice floe monitoring system 42 includes a satellite input 74 that receives data from satellite 48, a UAV input 79 that receives data from UAV 44, an AUV input 81 that receives data from AUV 46, and support vessel input 84 that receives data from support vessels 50.

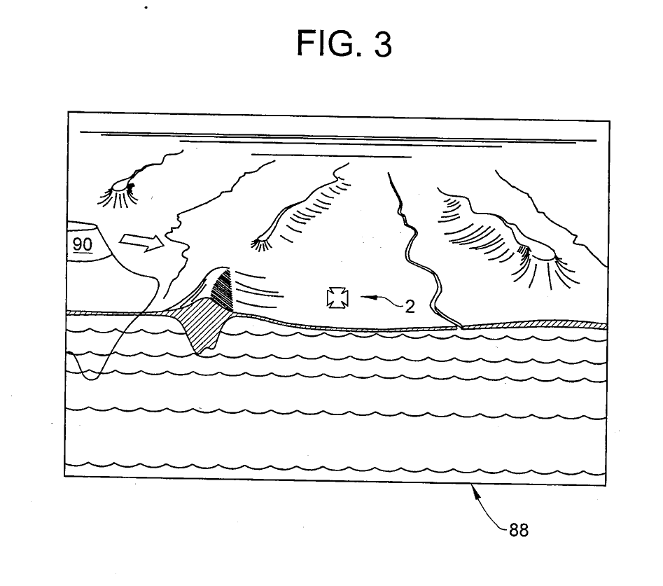

In further accordance with the exemplary embodiment, ice floe forecast system 66 monitors ice floes near arctic floating platform system 2. Ice floe forecast system 66 scans for ice floe speed, ice floe thickness and the like to create a 4-D graphical representation of the ice floe, such as shown at 88 in FIG. 3. Ice floe forecast system 66 predicts a location and direction of a hazardous ice condition, such as shown at 90. Upon detecting hazardous ice condition 90, ice floe monitoring system 42 outputs an alert through an alert output 92 to support vessels 50. In addition, evacuation system 68 determines a safe harbor location 94 and a navigational course 97 to safe harbor location 94 and back to lower hull portion 6 at original anchor point 18. Ice floe monitoring system 42 also includes a communication system output 104 that provides a communication link to support vessels 50, land based systems (not shown) and the like.

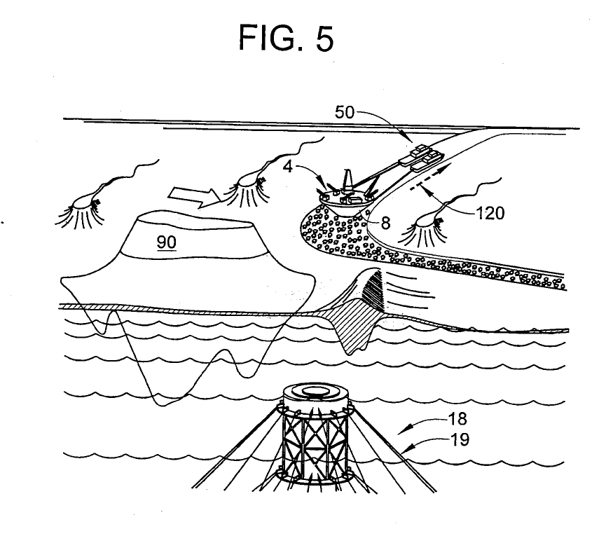

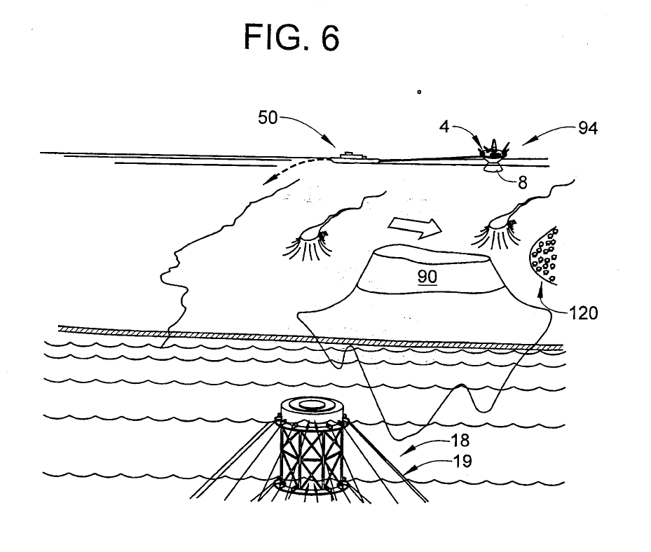

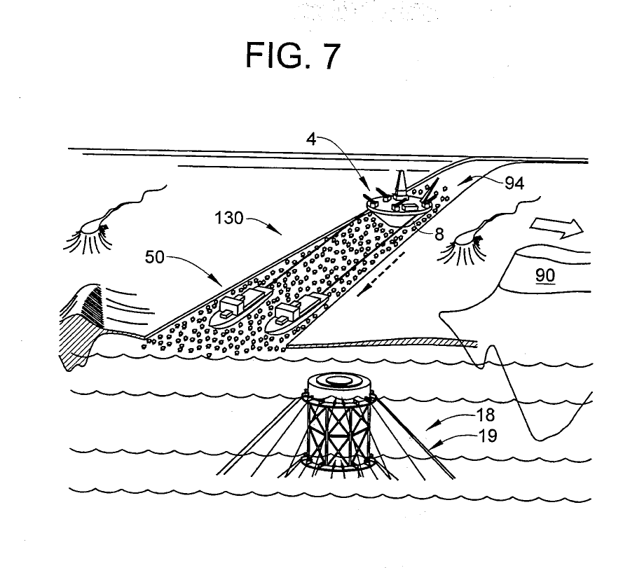

As shown in FIG. 4, prior to hazardous ice condition 90 reaching arctic floating platform system 2, upper hull portion 4 detaches from lower hull portion 6. Support vessels 50 proceed along an approach course 115 calculated by evacuation system 68. Approach course 115 represents a course that avoids ice hazards and allows support vessels 50 to safely and quickly arrive at original anchor point 18. Support vessels 50 connect to upper hull portion 4 and proceed along an evacuation course 120, as shown in FIG. 5. Evacuation course 120 avoids hazards and represents a fast and safe route to safe harbor location 94. As shown in FIG. 6, support vessels 50 remain with upper hull portion 4 at safe harbor location 94. Support vessels 50 will continuously re-position to avoid contact with upper hull portion 4. Further, ice alert system 40 continuously updates safe harbor location 94 to ensure upper hull portion 4 is in an area away from hazardous ice conditions. Once hazardous ice condition 90 has passed, support vessels 50 transport upper hull portion 4 along a return course 130 to original anchor point 18, as shown in FIG. 7. Once back at original anchor point 18, upper hull portion 4 is re-joined to lower hull portion 6.

At this point it should be understood that exemplary embodiments describe a system for monitoring for hazardous ice conditions in ice floes around an artic floating platform system. In addition, the system determines a safe harbor location as well as navigational courses to and back from the safe harbor location. The system also continuously monitors the ice floe to ensure that the safe harbor location remains safe. If changes in the ice floe occur, the system will determine a new safe harbor location. The system relies on multiple sources for ice floe data including UAV's, AUV's, satellites, as well as data from support vessels and the like that provide for a more accurate prediction of ice floe characteristics. In this manner, the arctic floating platform system remains on station in operation while being afforded an alert and support system that will transport the upper hull away from hazardous ice conditions.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

What is claimed is:

1. An ice alert system comprising:
an ice floe monitoring system;
an ice floe forecast system operatively connected to the ice floe monitoring system, the ice floe forecast system being configured to determine a hazardous ice condition; and
an evacuation system operatively connected to the ice floe forecast system, the evacuation system being configured and disposed to determine, in response to the hazardous ice condition, a safe harbor location, and a navigational course from an original anchor point to the safe harbor location.

2. The ice alert system according to claim 1, wherein the ice floe monitoring system includes at least one of an unmanned aerial vehicle (UAV), an autonomous undersea vehicle (AUV), and satellite data.

3. The ice alert system according to claim 1, wherein the evacuation system is configured and disposed to substantially continuously update the safe harbor location.

4. The ice alert system according to claim 1, wherein the evacuation system is configured and disposed to calculate a navigational course from the safe harbor location to an original anchor point.

5. The ice alert system according to claim 1, further comprising: a communication system output operatively connected to the ice floe monitoring system, the communication system output being configured and disposed to communicate safe harbor location data, and course data to one or more support vessels.

6. The ice alert system according to claim 1, wherein the ice floe forecast system is configured and disposed to determine at least one of ice floe thickness, and ice floe movement.

7. An artic floating platform system comprising:
a subsea platform portion;
an upper hull portion detachably coupled to the subsea platform portion; and
an ice alert system operably coupled to the upper hull portion, the ice alert system comprising:
an ice floe monitoring system;
an ice floe forecast system operatively connected to the ice floe monitoring system, the ice floe forecast system being configured to determine a hazardous ice condition; and
an evacuation system operatively connected to the ice floe forecast system, the evacuation system being configured and disposed to determine, in response to the hazardous ice condition, a safe harbor location, and a navigational course from an original anchor point to the safe harbor location.

8. The arctic floating platform system according to claim 7, wherein the ice floe monitoring system includes at least one of an unmanned aerial vehicle (UAV), an autonomous undersea vehicle (AUV), and satellite data.

9. The arctic floating platform system according to claim 7, wherein the evacuation system is configured and disposed to substantially continuously update the safe harbor location.

10. The arctic floating platform system according to claim 7, wherein the evacuation system is configured and disposed to calculate a navigational course from the safe harbor location to an original anchor point.

11. The arctic floating platform system according to claim 7, further comprising: a communication system output operatively connected to the ice floe monitoring system, the communication system output being configured and disposed to communicate safe harbor location data, and course data to one or more support vessels.

12. The arctic floating platform system according to claim 7, wherein the ice floe forecast system is configured and disposed to determine at least one of ice floe thickness and ice floe movement.

13. The artic floating platform system according to claim 7, wherein the ice floe forecast system provides a 4-D graphical output representing the ice floe.

14. A method of evacuating an arctic floating platform system comprising:
sensing through at least one of an unmanned aerial vehicle (UAV), an autonomous underwater vehicle (AUV), and a satellite ice floe data of an ice floe at the arctic floating platform system;
detecting a hazardous ice condition in the ice floe moving toward the arctic floating platform system;
determining a safe harbor location;
calculating a navigational course from an original anchor point to the safe harbor location;
disconnecting an upper hull portion of the arctic floating platform system from a lower hull; and
transporting the upper hull portion to the safe harbor location.

15. The method of claim 14, further comprising:
determining a new safe harbor location as the ice floe moves; and
re-positioning the upper hull to the new safe harbor location.

16. The method of claim 14, further comprising: calculating a navigational course from the safe harbor location to the original anchor point.

17. The method of claim 14, wherein detecting a hazardous ice condition includes sensing an area of ice floe thickness that exceeds a desired ice floe thickness approaching the arctic floating platform system.

18. The method of claim 14, wherein calculating a navigational course from an original anchor point to the safe harbor location includes calculating a course that avoids hazardous conditions between the original anchor point and the safe harbor location.

19. The method of claim 14, further comprising: calculating navigational positions of support vessels relative to the upper hull portion in the safe harbor location.

20. The method of claim 14, further comprising: producing a 4-D graphical representation of the ice floe.
